(19) United States
(12) Patent Application Publication
(10) Pub. No.: US 2013/0170241 A1
(43) Pub. Date: Jul. 4, 2013

(54) HANDLE OF AN OPENING ELEMENT OF A VEHICLE, COMPRISING A GRIP PART

(71) Applicants: Guillaume Lesueur, Creteil (FR); Antonio Rocci, Settimo Torinese (IT)

(72) Inventors: Guillaume Lesueur, Creteil (FR); Antonio Rocci, Settimo Torinese (IT)

(73) Assignee: VALEO S.P.A., Santena (TO) (IT)

(21) Appl. No.: 13/811,670

(22) PCT Filed: Jul. 22, 2011
(86) PCT No.: PCT/EP11/62657

§ 371 Date: Mar. 12, 2013

(30) Foreign Application Priority Data
Jul. 30, 2010 (IT) MI2010A001450

(51) Int. Cl. E05B 65/12; B60Q 1/00

(52) U.S. Cl. CPC E05B 85/103; E05B 83/36; B60Q 1/00
USPC 362/501; 292/336.3; 70/91

(57) ABSTRACT

The invention relates to the handle (4) of an opening element (2) of a vehicle, comprising a grip part (12) and a flap (14) mounted in such a way that it moves between a position wherein it fills an opening (22) extending in the continuation of the grip part and enabling said grip part to be handled; and a position wherein it frees up the opening.

The invention relates to handles for vehicle opening leaves.

Handles for opening leaves are a component which has a significant influence on the style of the vehicle bearing them. In this respect, vehicle manufacturers often seek to arrange the handle in the plane of the door so that it occupies a flush position (this being known as a flush arrangement), and more generally to render the handle as invisible as possible. Such flush door handles also have the advantage of reducing the aerodynamic noise caused by the rush of air as the vehicle is being driven along.

Handles are thus known which externally exhibit only a planar wall extending in the plane of the opening leaf. This is a wall of a component that the user has first of all to pivot in order to make it project from the opening leaf so that it can be operated in order to open the leaf. Such a door handle proves to be somewhat unergonomic.

Another door handle is known which constantly leaves an opening into which the user can insert a hand so that the user can easily operate the handle. Such a handle is more ergonomic than the previous one, but also far more visible.

It is an object of the invention to create a door handle which is both ergonomic and relatively invisible.

To this end, the invention provides a handle for a vehicle opening leaf, which comprises a grasping part and a flap mounted such that it can move between:
a position in which it occupies an opening extending flush with the grasping part and enabling the latter to be handled; and
a position in which it uncovers the opening.

Thus, when the flap is in its position in which it occupies the opening, it renders the handle relatively discrete. It is notably possible to envision that, in this position, the flap extends in an external local plane of the opening leaf so that its position is a flush position. When the flap uncovers the opening, this latter makes it easier to operate the handle so that the user can handle the opening leaf. The user therefore has an opening via which to access the grasping part and this opening is occupied by the flap for the rest of the time. This then yields a handle that is both ergonomic and not very visible on the opening leaf.

For preference, the flap is mounted such that it can slide with respect to a frame of the handle.

Advantageously, the handle comprises a motor able to cause the flap to move from the occupying position to the uncovering position.

The user is therefore spared the need to move the flap in order to operate the grasping part.

For preference, the handle comprises a decelerator of a movement of the flap.

This decelerator smoothes the speed at which the flap moves, notably under the effect of the motor. This then yields a movement which is more elegant and which the user perceives as a sign of top-of-the-range quality.

For preference, the handle comprises means designed to cause the flap to uncover the opening when a signal is received via a wireless connection.

It may, for example, be a signal transmitted by a component of the vehicle or by a component borne or carried by the user and which automatically triggers the uncovering by the flap when the user gets close to the vehicle. The handle is therefore particularly easy to operate.

Advantageously, the handle is arranged to allow the flap to be displaced manually to cause it to move from the occupying position to the uncovering position.

This is preferably a downgraded mode provided on the assumption that there may be some problem that prevents the motor from causing the flap to uncover the opening. The user therefore retains the option in such instances to displace the flap himself in order to operate the grasping part.

For preference, the handle comprises means, separate from the grasping part, for immobilizing the flap in the uncovering position.

Thus, these means retain the flap to make the grasping part easier for the user to operate.

For preference, with the grasping part being mounted such that it can move between a rest position and an open position, the handle is designed such that the flap cannot leave the uncovering position when the grasping part is in the open position.

This is a safety measure which prevents the flap from returning while the grasping part is being operated.

In one embodiment, the grasping part is arranged such that, in the open position, it prevents the flap from leaving its uncovering position.

For preference, the flap is designed such that, in the occupying position, it prevents the handle from leaving its rest position under the effect of an acceleration toward the outside of the opening leaf.

Thus, if the vehicle experiences an impact that has a tendency to displace the grasping part as far as its opening position, the flap immobilizes it in the rest position. That prevents unwanted opening of the opening leaf in such circumstances and therefore maintains the safety of the passengers of the passenger compartment.

For preference, the handle comprises a light source for illuminating the opening.

The light thus produced makes it easier to operate the grasping part, notably in partial or total darkness.

Advantageously, the grasping part is mounted such that it can move between a rest position in which it conceals a lock of the handle and an open position in which it uncovers the lock.

Thus, in the rest position, the lock is protected from dirt and knocks. It is also more difficult for a perpetrator unfamiliar with the model of vehicle to locate. It may be a simple emergency lock used only when the vehicle remote locking system is not working.

The invention also provides a vehicle opening leaf, which comprises a handle according to the invention, the grasping part and the flap extending at rest in at least one local plane of a main external wall of the opening leaf.

Thus, the handle is particularly invisible on the opening leaf.

Advantageously, the handle is arranged such that the flap moves from the occupying position to the uncovering position by being pushed into a depression made in the external face of the wall.

The travel of the flap is therefore entirely within the volume occupied by the opening leaf.

Further features and advantages of the invention will become even further apparent from the following description of one embodiment given by way of entirely nonlimiting example with reference to the attached drawings in which:

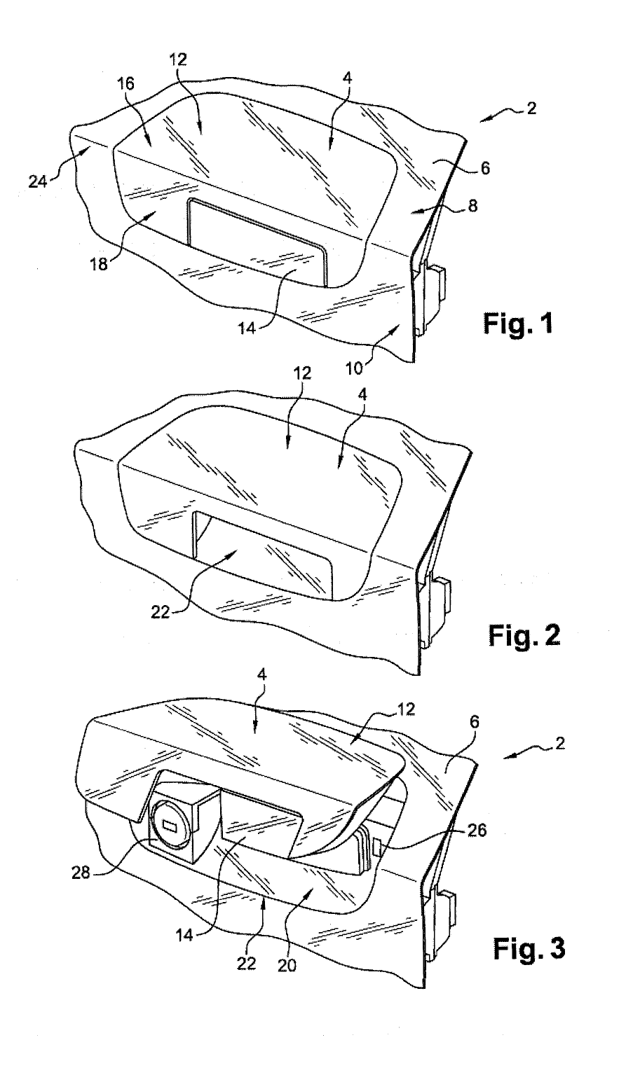

FIGS. 1 to 3 are three partial perspective views of an opening leaf according to the invention showing three stages in the operation of the door handle from the outside of the opening leaf;

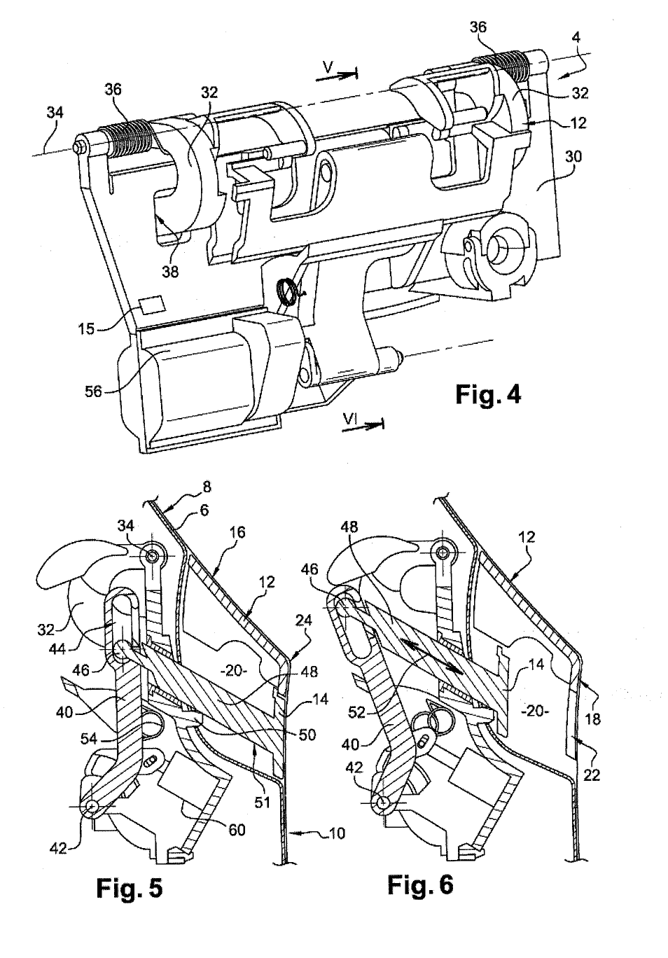

FIG. 4 is a perspective view of the door handle as viewed from the inside of the opening leaf;

FIGS. 5 and 6 are views in cross section of the door handle on the plane V-VI of FIG. 4 with the flap in the occupying position and with the flap in the uncovering position, respectively; and

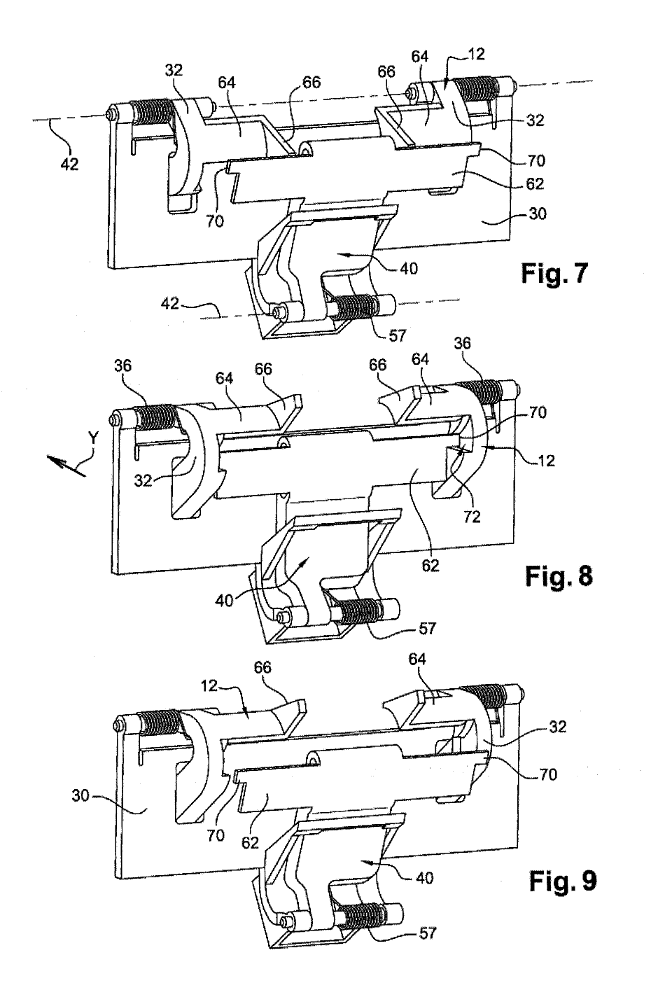

FIGS. 7 to 9 are views similar to FIG. 4 illustrating three different circumstances of operation of the handle.

The figures illustrate one embodiment of a motor vehicle opening leaf 2 comprising a handle 4 according to one embodiment of the invention. It is assumed here that the opening leaf 2 is a door to the driver's seat of the vehicle. However, it could also be a front passenger door, a rear passenger door or even a tailgate.

The opening leaf 2 comprises a main external wall 6 which notably has two external faces 8 and 10 which are substantially planar and contiguous with one another and with the door handle 4. The face 10 is vertical while the face 8 is slightly inclined with respect to the vertical direction.

The handle 4 comprises a grasping part 12 and a flap 14. The grasping part 12 comprises a wall having two external faces 16 and 18. The opening leaf has a cavity 20 visible notably in FIG. 3, in this instance in the form of a depression extending to a region where the faces 8 and 10 meet. When the handle is in the rest position illustrated in FIG. 1, the face 16 of the grasping part conceals the depression in the top part and extends flush with the plane of the face 8, continuous therewith. Likewise, the face 18 hides the depression from the front and extends flush with the face 10, in the plane thereof and continuous therewith. The same is true of the flap 14.

The flap has a rectangular overall shape. At rest it occupies a rectangular vertical opening 22 the upper side and the two vertical lateral sides of which are delimited by a cutout made in the grasping part 12 and the lower edge of which is formed by a portion of an edge of the depression.

Normal operation of the handle as observed by the user will be described first of all.

In FIG. 1, the grasping part 12 and the flap 14 can therefore be distinguished from the wall 6 only via their respective edges. The depression 20 is in fact completely closed off and hidden from the outside by the grasping part and the flap. In the region occupied by the handle, the opening leaf has on view its two faces 8 and 10 which are continuous with those of the handle and meet to form an edge corner 24 that also runs along the grasping part 12.

It is assumed that the user is carrying or wearing an electronic unit of known type that allows the vehicle to identify him automatically by means of a wirelessly transmitted signal, notably as the user comes up close to the vehicle. This is, for example, an ignition key for the vehicle that also allows access to the vehicle. Provision may also be made for this identification to take place when the user operates a button on a remote control unit.

The handle 4 comprises means 15 able to recognize such a signal and then command the movement of the flap 14. For this reason, the flap is mounted with the ability to effect a translational movement with respect to a frame of the opening leaf between a position in which it occupies the opening 22, which position is illustrated in FIG. 1, and a position in which it uncovers this opening, as illustrated in FIGS. 2 and 3. The flap then extends in the bottom of the depression 20.

The retraction of the flap makes the opening 22 visible to the user. The user can therefore see that he can insert his fingers into this opening in order to operate the grasping part 12. The latter, which in this instance is of the paddle lever type, is mounted such as to be able to be rotated between a rest position illustrated in FIGS. 1 and 2 and an open position illustrated in FIG. 3 in which it, to a large extent, uncovers the depression 20 and extends some distance from the two faces 8 and 10 of the opening leaf, above and facing the latter.

The handle further comprises, in this particular instance, a light source 26 able to illuminate the depression 20 from the bottom or side thereof as soon as the flap 14 leaves the position of occupying this opening. The user therefore has an even clearer view of how to operate the grasping part 12.

The opening leaf comprises an opening mechanism of a conventional type which will not be detailed here and which is operated by the grasping part 12. It is therefore the user who, in operating the grasping part by displacing it from the rest position to the open position, causes the opening leaf to be unlocked and opens the latter.

The mechanism comprises a lock mechanism which can if necessary be controlled by an emergency lock 28 the end of which is visible on the outside of the opening leaf when the grasping part is in the open position. This end is concealed by the grasping part in the rest position. The lock is contiguous with the depression 20 one of the lateral walls of which it forms.

Provision is made that, in normal operation, the remote control performed by the user or the automatic recognition of the latter as indicated above also has the effect of unlocking the opening leaf so that the user does not need to insert a key into the lock 28. However, he retains the option of so doing in downgraded mode or if, in one embodiment, there is no provision for the aforementioned actions to lead to automatic unlocking of the opening leaf.

The makeup of the handle will now be detailed with reference to FIGS. 4 to 6.

The handle comprises a frame 30 rigidly fixed to the frame of the opening leaf 2. The grasping part 12 comprises two gooseneck arms 32 by means of which it is articulated to an upper end of the frame 30 about a horizontal axis 34. The latter is, in this particular instance, parallel to the longitudinal direction of the vehicle and to the edge corner 24. The arms 32 are in the form of circular arcs and pass through openings 38 formed in the frame 30.

The handle comprises two return springs 36 which tend to return the grasping part to the rest position of FIG. 2. To do so, the springs 36 bear firstly against the frame and secondly against the respective arms 32.

The handle 4 comprises a crank 40 which has one end, in this instance the lower end, articulated to the frame about an axis 42 parallel to the axis 34. At its upper end, the crank 40 has a housing 44 of rectilinear elongate shape in which a proximal end of an internal arm 48 of the flap 14 is slideably mounted. The direction of sliding 52 of the flap runs in a plane perpendicular to the axis 42 and in this instance is inclined with respect to the vertical and horizontal directions. The crank in this particular instance has a cranked shape when viewed in such a plane. At its distal end, the arm 48 carries the external wall of the flap.

The frame 30 comprises a guide 50 against which the faces of the arm 48 bear. The connection between the crank 40 and the end 46 and the bearing of the arm 48 against the guide 50 provide sliding guidance of the flap 14 between the occupying position illustrated in FIGS. 1 to 5 and the uncovering position illustrated in FIGS. 2, 3 and 6.

In the former of these positions, the crank occupies a forward position and the end 46 extends into the bottom of the housing 44. Rotation of the crank about the axis 42 causes this end to rise up in the housing and causes the flap to slide to the bottom of the depression 20, into the uncovering position. The crank has been illustrated in both positions in FIG. 4.

The handle comprises at least one spring 54 bearing firstly against the frame 30 and secondly against the crank 40 and holding the flap in position in a bistable manner. The spring 54 is therefore configured to give the flap stability in its two positions, occupying and uncovering. That means that when the flap is in the occupying position as in FIG. 5, the spring 54 tends to return it to this position if any external influence has a tendency to cause it to leave this position. Likewise, in the position in FIG. 6, if any external influence urges the flap toward the occupying position, the spring has a tendency to cause it to maintain the uncovering position.

The handle comprises a motor 56 fixed rigidly to the frame and arranged to cause the crank to rotate in order to move the flap from the occupying position to the uncovering position and vice versa. In this particular instance, the crank bears a toothed sector meshing with a splined shaft of the motor so that the latter can operate the crank in the two directions of rotation. The motor is rated to overcome the return force of the bistable spring 54.

The handle comprises a damper 60 a casing of which is rigidly fixed to the frame and a moving part of which is connected to the crank. The purpose of this damper is to smooth and slow the movement of the flap in both directions. It is also intended to reduce the noise generated by the movement of the components. The damper ensures that the flap opens and closes gently.

If a vehicle fault or a problem with the door handle prevents the flap 14 from being operated using the motor 56, it remains possible to move the flap 14 manually from the occupying position into the uncovering position. This is because the handle is in fact configured to allow such displacement of the flap under the effect of a force applied in this direction from outside the handle. Provision is therefore notably made for the connection between the motor and the crank to be reversible. In such an assumption, the user pushes the flap 14 manually, the flap being held in the uncovering position by the spring 54, and the user is then able to grasp the grasping part 12 in order to open the opening leaf or access the lock 28.

To avoid wrong moves or reduce the risks of accidents, for example when somebody is seeking to lock the vehicle while somebody else is operating the grasping part 12, the handle is arranged to prevent the flap 14 from returning to the occupying position when the grasping part is in the open position. Thus, there is no risk of the person operating the grasping part being trapped by the flap returning to the occupying position.

The mechanism provided for that purpose is illustrated notably in FIG. 7. In that respect, the crank 40 comprises a plate 62 which extends the crank on either side thereof parallel to the direction of the axis 34.

Each arm 32 of the grasping part 12 bears an extension extending in the direction of the other arm and itself bearing, at its free end, a spacer piece 66 of triangular overall shape visible notably in FIGS. 8 and 9 and each extending in a plane perpendicular to the axis 42. The handle is configured in such a way that, when the flap 14 is in the uncovering position, the plate 62 is in the retracted position in relation to the frame 30. Operation of the grasping part moving it from the rest position to the open position places the spacer pieces 66 facing the external face of the plate 62, in the path thereof, or even in abutment against the latter as illustrated in FIG. 7. The crank 40 is therefore prevented from pivoting to return the flap 14 to its occupying position. When the grasping part returns to its rest position, the spacer pieces 66 release the plate 62 and position themselves out of the path thereof, thus making it possible for the flap to return to the occupying position.

Moreover, the handle exhibits advantageous behavior in a lateral impact in the event of an accident, as illustrated in FIGS. 8 and 9. In such an instance, the grasping part 12 and the flap 14 experience accelerations in the direction Y which is the horizontal direction transverse to the direction of running of the vehicle, toward the outside thereof. Because of this acceleration, the grasping part 12 has a tendency to move from the rest position to the open position and the flap 14 is stressed while being held in the occupying position. The handle is configured in such a way that, in such an instance, the flap blocks any movement of the grasping part from its rest position.

To this end, the plate 62 bears lugs 70 on its two upper lateral ends. The goosenecks 32 on their internal face have cavities 72 that form respective receiving housings for the lugs 70 when the handle is at rest. These housings are configured to allow prior rotation of the crank as long as the grasping part 12 remains in the rest position. FIGS. 8 and 9 thus illustrate the positions of the crank corresponding to the occupying and uncovering positions of the flap, with the grasping part remaining fixed. The housings are configured such that the gooseneck butts against the corresponding lug 70 and interferes with it if any attempt is made to turn the grasping part to bring it into the open position while the flap is still in the occupying position. Thus, when the grasping part is urged outward from its rest position under the effect of a sudden sharp acceleration caused by a side impact, any movement of the grasping part is prevented by the flap in the occupying position. By contrast, when the handle is being used, with the flap having previously been placed in an uncovering position as in FIG. 9, the positioning of the lugs 70 outside the cavities 72 leaves the grasping part 12 free to move.

Of course, numerous modifications can be made to the invention without departing from the scope thereof.

Provision may be made to dispense with the motor 56. That is the situation that has been illustrated in FIGS. 7 to 9. An additional spring 57 is then provided which returns the flap to the occupying position and bears against the latter and against the frame 30. The bistable retaining spring 54 is then dispensed with also.

1. A handle for a vehicle opening leaf comprising:
a grasping part and a flap mounted such that the flap moves between:
a position in which the flap occupies an opening extending flush with the grasping part and enabling the latter to be handled; and
a position in which the flap uncovers the opening.

2. The handle as claimed in claim 1, in which the flap is mounted such that the flap slides with respect to a frame of the handle.

3. The handle as claimed in claim 1, further comprising a motor able to cause the flap to move from the occupying position to the uncovering position.

4. The handle as claimed in claim 1, further comprising a decelerator of a movement of the flap.

5. The handle as claimed in claim 1, further comprising means for causing the flap to uncover the opening when a signal is received via a wireless connection.

6. The handle as claimed in claim 1, wherein the handle is arranged to allow the flap to be displaced manually to cause the flap to move from the occupying position to the uncovering position.

7. The handle as claimed in claim 1, further comprising means, separate from the grasping part, for immobilizing the flap in the uncovering position.

8. The handle as claimed in claim 1, wherein, with the grasping part being mounted such that the grasping part moves between a rest position and an open position, the handle does not allow the flap to leave the uncovering position when the grasping part is in the open position.

9. The handle as claimed in claim 8, in which the grasping part is arranged such that, in the open position, the grasping part prevents the flap from leaving the uncovering position.

10. The handle as claimed in claim 1, wherein, with the grasping part being mounted to move between a rest position and an open position, the flap, in the occupying position, prevents the handle from leaving the rest position under the effect of an acceleration toward the outside of the opening leaf.

11. The handle as claimed in claim 1, further comprising a light source for illuminating the opening.

12. The handle as claimed in claim 1, wherein the grasping part is mounted to move between a rest position in which the grasping part conceals a lock of the handle and an open position in which the grasping part uncovers the lock.

13. A vehicle opening leaf, comprising:
a handle as claimed in claim 1, the grasping part and the flap extending at rest in at least one local plane of a main external wall of the opening leaf.

14. The opening leaf as claimed in claim 13, wherein the handle is arranged such that the flap moves from the occupying position to the uncovering position by being pushed into a depression made in the external face of the wall.
